(19) United States
(12) Patent Application Publication
(10) Pub. No.: US 2012/0054099 A1
(43) Pub. Date: Mar. 1, 2012

(54) Method and system for virtual processing of checks deposited in automated teller machines

(75) Inventors: James H. Fox, Frisco, TX (US); Jeffrey B. Allen, Frisco, TX (US); Christopher K. Debrecht, Plano, TX (US); James W. Simms, Wylie, TX (US)

(73) Assignee: ABC COIN SORTING COUNTING SUPPLY INC., Frisco, TX (US)

(21) Appl. No.: 12/806,920

(22) Filed: Aug. 24, 2010

(51) Int. Cl. G06Q 40/00

(52) U.S. Cl. 705/43

(57) ABSTRACT

A system and method enable receipt of check deposits, and other transactions, at a remote terminal such as an automated teller machine (ATM). The ATM images the checks and sends the images and associated account and transaction information to a manager server. The manager server creates a virtual deposit slip for each transaction, and batches one or more transactions for further processing at a work station. The manager server sends the batches, which may include images, transaction data, and virtual deposit slips, to a work station. A teller may view the batches, perform verification and correction activities, and scan the batches using an emulated scanner that is part of the work station software. The virtually scanned batches may be sent to an additional processing system or to a clearing center.

### TECHNICAL FIELD OF THE INVENTION

The invention relates generally to the field of processing financial instruments and, more particularly, to systems and methods by which a check can be deposited in an automated teller machine and virtually processed.

### BACKGROUND OF THE INVENTION

Automated Teller Machines (ATMs) are generally known and have been in existence for some time. ATMs allow a user that holds a bank account to perform various transactions related to that account. The transactions may be performed at an ATM location, which is commonly remote from the bank supporting the particular ATM. In some cases, an ATM is located in the lobby of its supporting bank or adjacent to, and just outside, its supporting bank. This allows the user to access the ATM during times when the bank is otherwise closed. In other cases, the ATM may be located in a location, which is more remote from the bank. These locations can be virtually anywhere, but are typically in retail areas and places where there is high pedestrian traffic.

Some of the various transactions which may be performed by the user are checking an account balance, depositing checks and cash, withdrawing funds, or transferring funds from one account to another. In order to make the deposit, the user accesses the appropriate account by inserting or swiping a card with a magnetic stripe. The magnetic stripe contains digitized information relating to the account, such as the account number. Typically, software associated with the ATM causes a graphic user interface (GUI) to prompt the user to enter the user's password. The password is commonly entered on a keypad. Once the ATM software recognizes the user as the correct holder of the card, the user is prompted to select which type of financial transaction is desired.

According to a traditional method of making a check deposit, a customer goes to a bank, fills out a deposit slip and hands the deposit slip and checks to a teller. The user fills out the deposit slip reflecting the user's name, the number of the account to which the funds will be deposited and the amount of the check. For a deposit of multiple checks, the user typically lists the various check amounts on a calculation template located on the back of the deposit slip. The user then totals the amounts and lists the total amount of the checks in a corresponding location on the front of the deposit slip. The total check amount may be added to a cash deposit amount for a total deposit amount. A withdrawal amount may be subtracted for a grand total of the deposit. The teller scans the deposit slip and checks using a scanner.

Current methods for depositing checks into ATMs, and processing those checks, involve what may be referred to as either a manual method or a custom integration method. The manual method involves collection of the deposited checks in the ATM, followed by manual retrieval of the physical checks and conventional processing using known check scanning equipment, such as that found at teller windows of larger banks. A user may swipe a bank card through a card reader on the ATM. The user may then be prompted to choose one of a number of different transactions including making a check deposit. The user inserts the checks, which may be imaged by the ATM. Some ATMs perform a character amount recognition (CAR) process. The ATM may ask the user if the deposit amount is correct and the user may make changes using a keypad associated with the ATM. The ATM usually provides an indication, either as part of the GUI or by a receipt, of the amount of the deposit. The receipt reflects the amount of the deposit as read by the ATM and/or as entered by the user and is subject to verification by way of the check processing steps that follow the user's ATM transaction. Moreover, even assuming that the user has entered all of the deposit information correctly, the deposited funds are not typically available for withdrawal until the cash and checks have been verified, and the checks have cleared.

Checks processed according to the manual method must be physically retrieved from the ATM. This may be done by an employee, for example, when the ATM is located on the grounds of its supporting bank. When the ATM is more remote, retrieval of the deposits is usually performed by one or more armed security guards to which the retrieval process is outsourced. Once the deposits are retrieved, a bank employee, such as a teller, may go through the process of verifying that the checks are for the amounts indicated on the deposit slip and that the checks have been indicated as being for deposit in the correct account. Typically, the teller receives a stack of checks and must pull information from the system to make a determination as to what checks are associated with which customer and which transaction. The teller can also visually check to see whether there have been any changes made to the information on the check. Such changes could indicate fraud. The teller may also generate deposit slips for each transaction. In order to do so, the teller must organize the checks and get information from the associated banking systems regarding customer names, account numbers, etc., and verify that any customer-entered data is correct.

Once the deposit slips have been created and the checks have been verified as containing accurate and correct information, the checks and the deposit slips are then processed. The processing step typically involves scanning the deposit slip and the checks in a scanning machine. One common example of a check scanning machine is the Panini®. The financial institution's existing check processing system is used to process, post, and clear the checks.

The custom integration method of check processing involves the acquisition of a check image at the ATM, followed by transmittal of that check image directly to a check processing company and bypassing the check scanning step normally performed by bank personnel. Consequently, the integration method also involves retrieving necessary information from a number of different platforms prior to delivering that information, together with the check image, to the check processing company.

### SUMMARY OF THE INVENTION

Part of the novel aspect of various embodiments involves recognizing certain shortcomings of current ATM check deposit systems. Current systems for receiving checks at ATMs, and for processing those checks, have several drawbacks. Certain current systems require manual retrieval of the deposited checks. This usually involves having armed security personnel drive to the ATM, open the machine, retrieve the checks, and deliver the checks to the bank that is associated with the ATM. Opening up an ATM, particularly an ATM remote from the bank facility raises issues of security, crime, and liability to customers. Once the checks have been delivered to the bank, a person must physically assess all of the checks, manually fill out a deposit slip by querying their systems for the information needed for the checks in each transaction, scan the checks and the deposit slips in a scanner, and process, post, and clear the checks. In these cases, the ATM is the equivalent of a high-cost drop box that adds significantly to the cost of conducting a check-depositing bank transaction. This cost is either passed on to the consumer or cuts into the profit of the bank providing the service.

There are also drawbacks associated with the custom integration method. One drawback is that development and implementation of these systems is often time consuming and complicated. This translates to high costs for implementation. Part of the complexity can be attributed to the fact that implementation affects platforms controlled by many different entities. Implementation requires coordination among the ATM manufacturer, the ATM owner, the integration developer, the bank, the bank's host, the bank's core system, and the check processing system. Integration involves changing settings in the software of the various platforms. These changes affect how each platform functions and interacts with the other platforms. It is often the situation that a change in one platform causes that platform to not work properly with one or more other platforms. It is common that the custodian of a component with the overall ATM check deposit and processing system will change one or more settings on their particular component. Thus, even after a custom integration has been performed, a change may be made to a certain component without coordination with the other components, particularly those components controlled by a different entity. In these cases, the system may simply fail to work. The custom systems also commonly involved blind processing. Images of deposited checks are sent directly to the check processor without someone viewing the actual deposits. This can create a fraud opportunity, especially since the customer can make changes to the checks, or enter deposit information at the ATM which does not accurately correspond to the check information. For instance, most custom ATM systems allow a customer to change a value that the ATM reads from the check, or to input values when the ATM did not read a value.

The invention, among other things, automates several steps involved in processing checks. In one embodiment, a system is provided that has software resident on an ATM, a manager server, and a work station. The ATM software provides certain functionality such as gathering check images created by the ATM, collecting the check images, and retrieving account data provided by a host. The manager server receives the check images and account data from the ATM, batches the transactions, and creates a virtual deposit slip for the check(s) in each customer transaction. The virtual deposit slip is an electronic image of a deposit slip with all the information normally used by the bank handling a deposit transaction. It is automatically created by the system and populated with the information corresponding to the check(s) being deposited in the transaction associated with the particular virtual deposit slip. The manager server can also provide other features such as an edit priority list established according to one or more predetermined criteria, such as whether the transaction involved any customer-initiated changes in the deposit information at the ATM site. The work station software allows a bank employee to virtually process one or more batches of checks. Thus, the work station software emulates a physical check scanner and provides a GUI for the employee to verify the check deposits of the various batches. Once the deposit information has been verified, a virtual batch header is created and each virtual deposit slip and its associated check(s) are virtually scanned by the emulated scanner, replicating the financial institution procedures in use prior to implementation. Their existing check processing software then processes, posts, and clears the items as normal, just as if the checks had been deposited in person at a teller window.

One or more embodiments may provide some, none, or all of the following advantages over current systems. According to some advantages, the systems may avoid the problems associated with the custom integration method such as the time it takes to develop a custom integration and coordinate the different entities that possess pieces of the needed information. Other advantages are that the system provides familiarity and ease of use by replicating certain existing procedures, and avoids “blind processing” by incorporating an edit checklist procedure. At the same time, problems associated with manual processing are also avoided. For instance, it is not necessary to physically retrieve the checks from the ATM. Nor is it necessary to manually create a deposit slip or physically scan the checks using a scanner.

### BRIEF DESCRIPTION OF THE DRAWINGS

FIG. 1 is a block diagram of a financial transaction system according to an embodiment of the invention;

FIG. 2 is a block diagram of the automated teller machine shown in FIG. 1;

FIG. 3 is a block diagram of the manager server shown in FIG. 1;

FIG. 4 is a block diagram of the work station shown in FIG. 1; and

FIG. 5 is a flow chart illustrating an example process of a check deposit transaction and processing according to an example embodiment of the invention.

### DETAILED DESCRIPTION OF THE INVENTION

According to various embodiments, a system is provided as an improvement over current ATM check deposit and processing technology or as an initially preferred method. Among other things, the system automates several steps involved in processing ATM-deposited checks. In one embodiment, a system is provided that has software resident on an ATM, a manager server, and a work station. The ATM software provides certain functionality such as collecting the ATM-created check images, and storing account data provided by a host.

The manager server receives the check images and account data from the ATM (which is provided by the host), batches the transactions, and creates a virtual deposit slip for the check(s) in each customer transaction. The virtual deposit slip is an electronic image of a deposit slip normally used by the bank handling the ATM check deposit transaction. It is automatically created by the system by pulling information from the checks and the account information pushed down from the ATM host to the ATM's electronic journal. Then the system populates the appropriate information corresponding to the check(s) being deposited in the transaction associated with the particular virtual deposit slip. The manager server can also provide other features such as an edit priority list established according to one or more predetermined criteria, such as whether the transaction involved any customer-initiated changes in the deposit information at the ATM site.

The work station software allows a bank employee to virtually process one or more batches of checks. Thus, the work station software emulates a physical check scanner and provides a GUI for the employee to verify the check deposits of the various batches. Once the deposit information has been verified, each virtual deposit slip and its associated check(s) are virtually scanned by the emulated scanner. The resulting data is then forwarded to the affiliated check processing company in due course. One way of viewing the system is that the automated ATM check deposit process mimics many aspects of the manual process involved when a customer interacts physically with a bank teller.

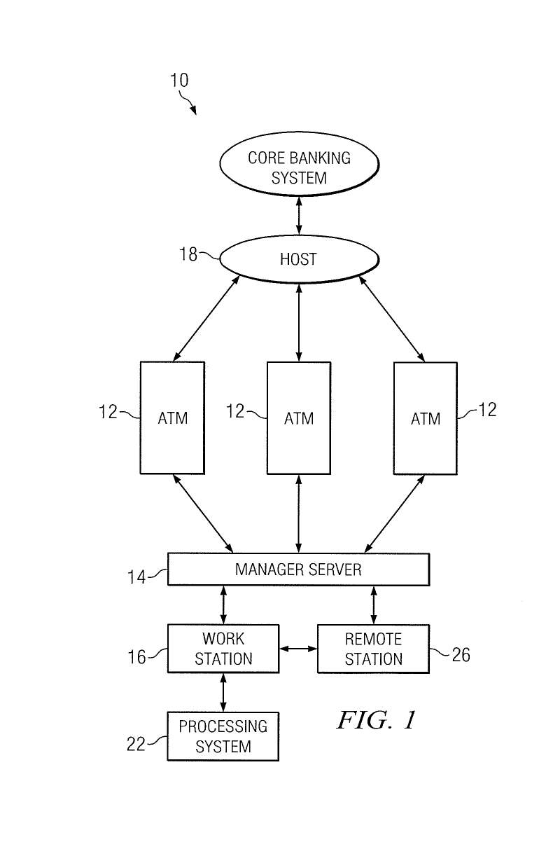

As shown in FIG. 1, for example, a system 10 is provided for allowing one or more checks to be deposited at an ATM machine, and to automate certain steps in the processing of those checks. System 10 includes one or more automated teller machines (ATMs) 12. Other terminology may be used to identify ATM 12, such as automated banking machine, cash machine, financial transaction machine, kiosk, etc. Further, system 10 may incorporate other types of financial transaction kiosks as will be reasonably understood by those having ordinary skill in the art. ATM 12 is operable to enable a customer to conduct a number of financial transactions such as depositing and withdrawing cash into and from an account. The account may be a checking account, savings account, or any other type of financial account. ATM 12 may enable other services such as the transfer of assets from one account to another, payment of bills, checking an account balance, etc. Preferably, ATM 12 is operable to receive one or more checks for deposit from the customer. ATM 12 scans the items as they are deposited in the unit eliminating the need for an envelope. ATM 12 may or may not perform character amount recognition (CAR) and/or legal amount recognition (LAR) on the items. ATM 12, together with other components of system 10 enables the receipt and processing of the checks without the customer having to fill out and insert a deposit slip.

ATM 12 is connected to a number of different components, which will be described in further detail. One or more of the components may comprise hardware and/or software. The components are operable to communicate with one another. The communication between components may be conducted over any suitable existing, or future, telecommunication path employing any suitable existing, or future, telecommunication technology. For example, telecommunication may occur over one or more communication networks employing one or more technologies such as wide area networks, local area networks, virtual private networks, metropolitan area networks, etc. The communication may employ any suitable protocol including, without limitation, transmission control protocol, internet protocol, hypertext transfer protocol, file transfer protocol, and the like. Other technologies may be employed such as Wi-Fi, Bluetooth, cloud computing, etc. The communications may employ cellular, wireless, land lines, cloud computing and other technologies. Information may be transferred using any known switching and data transfer technologies.

ATM 12 is connected to a manager server 14 and an ATM host 18. ATM host 18 is also connected to a core banking system 20. Manager server 14 is also connected to a work station 16. Work station 16 is also connected to a check processing system 22. It should be understood that the connections illustrated in FIG. 1 are for example purposes only. Various embodiments may comprise these, or similar components, which may be connected in arrangements that are different from that illustrated. For example, ATM 12 may be connected directly to work station 16, or any of the other components, depending on any number of considerations such as the desired manner of information exchange between components.

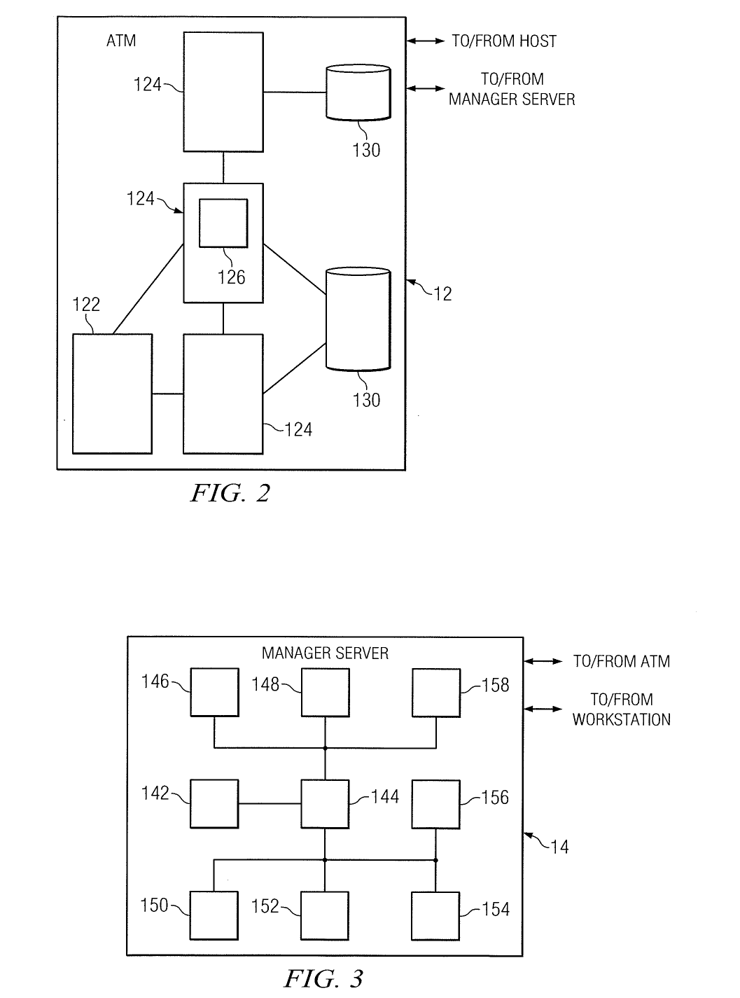

As shown in FIG. 2, ATM 12 comprises one or more computers 128 capable of executing various software programs and modules. ATM 12 may also include one or more databases 130 for storing information associated with the services it provides. The computers may include any suitable type and the term “computer” is not intended to be limiting as to any particular type of computing platform or processor. Similarly, any suitable databases may be employed and the term “database” is not intended to be limiting as to any particular type of database. The one or more computers and databases may be linked together in any suitable manner using any known, or future, computer networking technology. Other components within system 10 also comprise one or more computers and databases and those components may likewise use any suitable computers and databases that are connected using any known, or future, networking technology.

As further illustrated in FIG. 2, ATM 12 also comprises a check imager 122, which is operable to create an electronic image of a check deposited by a customer. The image of the check may be stored on a database within the ATM 12, or a database located remotely from ATM 12. At least one computer 124 within ATM 12 hosts a local software module 126 for controlling, at the ATM, various steps associated with receiving and processing deposited checks. It should be recognized that module 125 may, in practice, comprise multiple modules and make take any suitable form. Thus, module 126 may comprise one or more software programs executable on one or more processors, or any suitable combinations of software and hardware for controlling the ATM functions. These functions include, without limitation, recognizing that a check is being, or has been, deposited into the ATM, reading certain information on the check, and causing check imager 122 to make an image of the check. Imager 122 can create an image of the front and back of each check, and these images can be used by the system in its various processing steps. As the check images are collected and stored, the storage may be performed according to any desired set of criteria. For example, a single electronic file may be created for each check. Alternatively, a single file may include images and associated information for multiple checks. For instance, the information for multiple checks deposited by a single customer in one transaction may be included in a single electronic file. Each file may include the check image and other data, or electronic journal information, associated with the check such as the routing number, account number, and the amount of the check. The electronic file may also include other data such as data linking the file to one or more other electronic files.

Preferably, ATM 12 is operable to delete information associated with particular checks and transactions once the information is transmitted to manager server 14. It should be understood that although the operation of ATM 12 and module 126 is described in connection with deposited checks, the various functions describe herein may be performed in connection with cash deposits or deposits of other financial, or non-financial, instruments. Non-financial instruments might include, for example, bill payment documents.

ATM 12 is connected to a host 18 and host 18 is connected to a core banking system 20. ATM 12 is operable to contact host 18 to request information associated with the account of the customer conducting a financial transaction at ATM 12. Host 18 may, in turn, contact core banking system 20 to gather the requested account information. For example, a customer that would like to deposit one or more checks to a certain bank account may make that request at ATM 12. ATM 12 may, in turn, contact host 18 for information associated with the account identified by the customer. Host 18 may contact core banking system 20 to determine various information associated with the identified account. This information may include, without limitation, one or more names, identification numbers, passwords, or other identifying data associated with the account, an account balance, account availability, other accounts linked to the particular account, and any other information such as account holds, fraud alerts, etc. Core banking system 20 may, for example, return a message to host 18 that the account selected by the customer is properly associated with the password entered by the customer and is available to receive check deposits. Host 18, for example, may inform ATM 12 that the customer identification is valid and that ATM 12 should accept checks for deposit into the identified account.

ATM 12 is also connected to a manager server 14. As further shown in FIG. 3, manager server 14 provides a number of functions associated with processing checks deposited at ATM 12. Manager server 14 includes a data hub 142, which is operable to receive data from, and send data to, other components in system 10. When data is received, either from ATM or derived by ATM 12, a data management mechanism (not expressly shown) may be provided to perform additional lookup or data transformation necessary to prepare the data for use by other components in the system. For example, data hub 142 is operable to receive batched check deposit information from ATM 12. Manager server 14 also includes controller 144 for controlling the operation of manager server 14. For instance, controller 144 may be operable to either request, or recognize receipt of, batched check deposit information from ATM 12. Once the batched data is received, controller 144 may perform additional processing of the data. Preferably, manager server 14 is operable to either batch transactions conducted at ATM 12 or, alternatively, to accept batched transactions from ATM 12. For instance, software resident on ATM 12 may be operable to batch one or more check deposit transactions by one or more customers. Each transaction in the batch may include one or more checks. It should be noted that this is an example only and the various embodiments described herein may be applicable to batching or processing of different transactions involving different financial instruments. Once manager server 14 pulls deposit information from ATM 12, it creates and controls a batching process.

This further processing may include, without limitation, encrypting the transaction batch data. Manager server 14 includes a data encryption module 146 to encrypt data, including the batched check deposit information received from ATM 12. Preferably, the further processing performed by manager server 14 is conducted in a manner to enable workstation 16 to be able to handle the information once it is delivered. Thus, encryption module 146 encrypts batched data in a manner in which work station 16 may decrypt the data or provide a public key for manager server 14 to decrypt data before transmission.

In certain embodiments, data from ATM 12 may either be pushed to or pulled by manager server 14. When data is pushed, it is the responsibility of ATM 12 to connect to the server and post any data of concern. However, when data is pulled by manager server 14, usually based on a schedule, manager server 14 will request or retrieve the information from ATM 12. The data can either be in a raw form a, or compiled in a proprietary format. In general, ATM 12 uses a proprietary structure called a package which is composed of a mixture of descriptive XML headers followed by binary data. The header can include information about the binary data, such as compression type, cyclic redundancy check (CRC) type, CRC value, binary data size, name, package type, and expandable user fields that can be application or package-specific. A batch may be composed of multiple packages structures, for example, sequentially. Because of this format, corruption within the batch does not render the entire batch unusable. The offending parts can be isolated and removed for later analysis.

Manager server 14 also includes a virtual deposit slip generator 148, which is operable to create one or more virtual deposit slips associated with the one or more check deposit transactions conducted at ATM 12. Generator 148 preferably employs one or more predefined deposit slip templates (not expressly shown) in an electronic file format. Preferably, the electronic file deposit slip templates correspond in format to a physical deposit slip employed by the host bank at its physical branch locations. Also, the templates may be modified to reflect additional data either provided by the customer, the host 18, the core banking system 20, or other components within system 10. Additional data for a modified deposit slip template may also be generated by one or more modules within manager server 14. As an example, if a particular check deposit transaction within a batch includes three checks being deposited into a particular checking account that the customer has with the host bank, virtual deposit slip generator 148 may first identify a deposit slip template associated with the host bank. Generator 148 may then create an electronic file including an image of the deposit slip template. Generator 148 may then accept certain field information and modify the deposit slip template to create a virtual deposit slip to be associated with the transaction involving the deposit of the three checks. The field information accepted and used by generator 148 may include, for example, the customer's checking account number and an associated routing number, the customer's name and additional identification data (such as address and telephone number), the amount of each of the three checks, and the total amount for deposit. In essence, the virtual deposit slip generator 148 takes away from the customer or a bank teller the task of manually filling out a deposit slip.

Manager server 14 also includes batch manager 150. Batch manager 150 is responsible for coordinating requests to batch transactions and/or process batched transactions. For example, batch manager 150 is operable to “check out” a batch in the event a request is received from a work station 16 to process that batch. If the processing at work station 16 is completed, or interrupted, batch manager 150 is operable to “check in” the particular batch. This avoids having multiple tellers or work station operators processing the same batch.

Manager server 14 also includes process packager 152. Process packager 152 builds a batch (or further processes an existing batch) to include all of the information needed for additional processing at work station 16. For example, this additional information may include images of the front and back of each check, images of the front and back of the virtual deposit slips associated with each check deposit transaction, and any other information associated with the transactions. It should be understood that process packager may either create, or collect from other components, the information needed to package a batch. Additionally, it should be understood that any particular information associated with a packaged batch may already be included in the batched data prior to being received and processed by, or after being processed by, process packager 152.

Manager server 14 preferably has a backup module 154, which is operable to back up any data received by, sent from, or hosted or resident (either permanently or temporarily) on manager server 14. Manager server 14 further includes a reporting and tracking module 156 for generating reports associated with the functions provided by manager server 14 and for tracking transactions and associated data.

Manager server 14 also includes a fraud detection module 158. Fraud detection module 158, among other things, maintains an edit priority list (not expressly shown). The edit priority list prioritizes certain transactions, from among one or more batches or other data relating to transactions, based on any of a number of predetermined criteria. The priority list represents an organization and display of one or more transactions within a batch (or multiple batches) for review during a following processing procedure. The review may be that conducted by a teller or work station operator, by someone at a clearinghouse, or by any other person associated with further processing or review of the deposit transaction data. Any number of desired parameters may be used to establish, populate, manipulate, or otherwise impact the edit priority list. By way of an example only, an edit priority list may be initially populated with all of the transactions from a batch. The initially-populated edit priority list may include a list of each transaction according to a preset criterion such as the date and time of the transaction. This may be accomplished, for instance, by having a software module review the time stamps associated with the transaction data. Once the edit priority list has been established, the list may be modified according to other criteria. For example, if a customer has manually changed information associated with a transaction, such an action may cause the software to move those particular transactions to the top of the list. These priority transactions may be further identified by an indicator, which may include, without limitation, an associated icon, a font style, highlighting, color, etc. The parameters for initially establishing the list, as well as for manipulating the list, may be layered. That is, a list may be established or modified according to a first parameter, and then according to a second parameter, and a third parameter, and so on. The parameters may include any information associated with the customer, the ATM, the manager server, the host bank, or the transactions themselves. For example, parameters may include, without limitation whether the customer has modified information associated with the transaction, what information has been entered by a customer at the ATM, the amount of the transaction, the date and/or time of the transaction, the geographic location associated with the transaction, the identity of the payor or the payee, the routing number, the account number, information associated with the account number, credit history information, customer's employer data, other personal information associated with the customer, username and password information, the number of attempts at entering a password or any other information, any fraud detection criteria, etc.

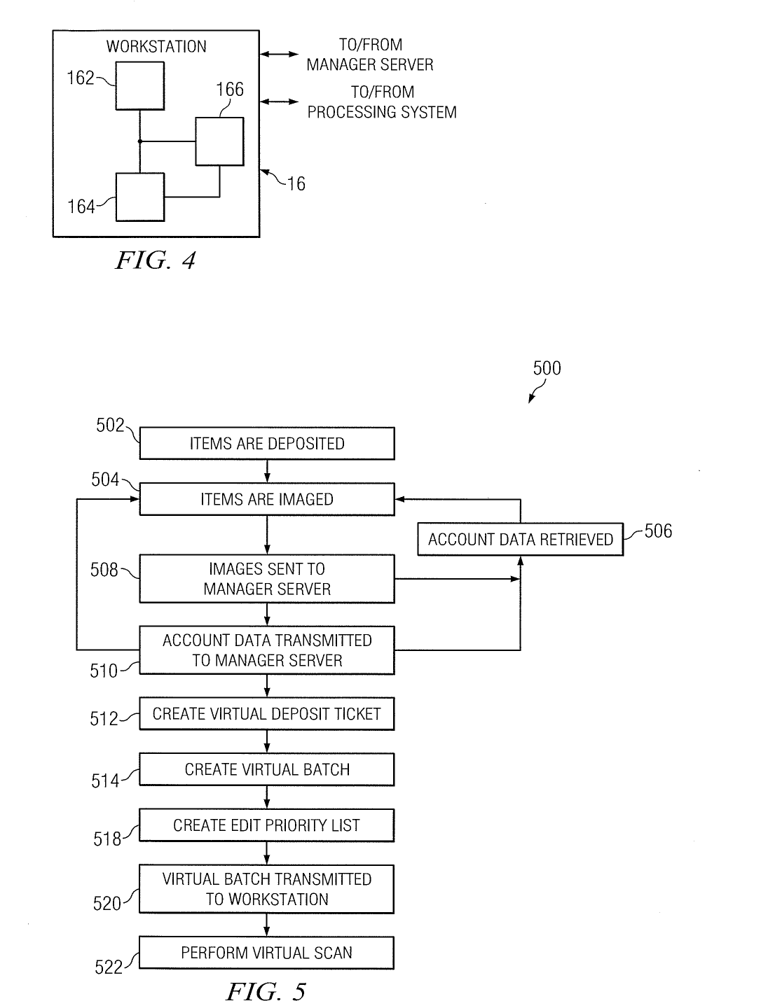

Manager server 14 is connected to work station 16, which, among other things, provides a platform for teller activity associated with processing the transactions. As shown in FIG. 4, work station 16 is operable to send and receive data to and from manager server 14. Work station 14 is further operable to send and receive information from check processing system 22. As mentioned elsewhere, it should be noted that the particular arrangement and interconnection of various elements in system 10 may be modified as desired to provide particular functionality, improved reliability and performance, or any other objective so desired. Work station 16 includes data processing module 162 for receiving and sending data, and for processing data. Work station 16 further includes a transaction management module 164. Module 164 provides various functions, which may include, for example, a notification function for notifying a teller when transaction batches are ready for further processing. Management module 164 may also be operable to enable a teller to request particular transaction batches, or to request any available batch, for processing. Preferably, when a batch is presented to a teller, the work station provides the teller with a graphic user interface for verification and adjustment of transaction data. For example, the work station 16 may provide the teller with a view of the edit priority list. The teller can review any or all of the items in the list. Alternatively, the system may only present certain items to the teller for review. For example, the teller may view a list that has all of the transactions associated with a batch, and all of the information associated with each transaction. The list may have prioritized one or more transactions according to one or more parameters so that several priority transactions are at the top of the list. As mentioned elsewhere, these several transactions may be, for example, transactions in which the customer manually altered certain transaction information which was initially automatically generated by one or more components in system 10. The teller may view the information associated with a transaction and, for instance, compare that information to an image of a check or a virtual deposit slip. It should be noted that the teller may be presented with other sources of information for comparison to the transaction information from the edit priority list. The teller may be enabled to adjust transaction information in the batch data to correct for errors discovered during the comparison and verification procedure.

Work station 16 also includes an emulated scanner 166 for virtually scanning a batch of transactions. The scanned information may include, for example, check images, virtual batch headers, virtual deposit slips, and the like. The emulated scanner may be embodied in one or more software programs. The software incorporates functionality to mimic the operation of conventional scanners. Thus, the emulator software may detect relevant financial, customer, and account data from the images originally taken by the ATM imager. The emulated scanner organizes this information and saves the images as electronic files. Each file may be associated with certain data relevant to its associate financial transaction. In certain embodiments, the emulated scanner 166 includes a plurality of drivers (not expressly shown), each of which corresponds to a different conventional scanner. Various drivers may support emulation of any conventional scanners such as, for example, Cannon®, Panini®, Digital Check®, or Unisys® scanners. Upon activation, the emulator software selects a driver associated with a certain type of scanner. For example, if the workstation operator is accustomed to working with a Panini® scanner, or if the bank's check processing and clearing system is set up to interface with the Panini® scanner, then the emulator software would select the driver for that particular scanner so that the emulator programs would emulate the operation of that particular scanner. Once the emulator has virtually scanned the checks, the virtual deposit slip, and any other associated electronic documents, the virtually-scanned information associated with a processed batch may be sent to check processing system 22 for additional processing.

Thus, at least in certain embodiments, the emulated scanner 166 acts as a clone of a bank's conventional scanner and imitates the hardware precisely so that the bank's existing check processing system behaves as if the deposit items have been manually scanned through the conventional hardware. This allows the items deposited at the ATM and the virtual deposit slips, etc. to automatically be sent into the bank's check processing system in a manner that remains consistent with the bank's previously-existing processes for handling the financial and non-financial instruments in question. When not in use, the emulated scanner allows for the scanning of items through conventional scanner hardware without interference.

In certain embodiments, work station provides additional functionality for the processing of batches. For example, work station 16 enables cataloging of all contents for a deposit batch, or any other transaction batch. Work station 16 also enables particular transactions to be removed from, or added to, a particular batch. This may occur as a result of any desired predetermined criteria and may be accomplished automatically or manually. For example, if a particular deposit within a batch cannot be processed at the time the batch is being processed, then the problem transaction may be pulled from the batch so that the remaining transactions may be processed. Supervisor routines are also available to enable reconciliation, error correction, and teller management. Work station 16 includes at least one display for enabling a teller or other user to view any check or virtual deposit slip. Scanner emulator tools are also available to enable a user to mimic the use of a physical scanner through the emulated scanner 166.

Work station 16 may be located, for example, at a particular physical bank location. Referring again to FIG. 1, one or more remote stations 26 may be linked to work station 16, or manager server 14, to enable tellers to work from locations that are remote from the bank. For instance, remote stations 26 may enable tellers to work from home or from mobile platforms. Among other things, this may allow for extended deposit processing cutoff times without having to staff a physical bank office.

Referring to FIG. 5, at least some embodiments provide one or more methods for processing checks deposited at an ATM. An example method 500 starts at step 502 where one or more financial or non-financial instruments are deposited at an ATM. For example, a bank customer may deposit several checks made out to the customer. The customer may deposit the checks through a deposit slot, for example, in the body of the ATM. The customer may intend that the value of the customer's checking account, or other selected account, be increased by the combined value of the checks being deposited.

At step 504, the ATM receives the checks and images each check as it is deposited. The ATM may have a camera, or other type of check imager for creating the images of the checks. The images may include an image of both the front and the back of each check. The images may be created as electronic files, which may be stored or communicated to other components in an ATM check deposit processing system.

At step 506, software on the ATM may execute in response to a signal. The signal may be provided by way of, for example, the customer having swiped a bank card, or some other type of financial card through a card reader attached to, or otherwise associated with, the ATM. The card reader may read code embedded within a magnetic stripe on the card. The code may reflect multiple pieces of data associated with the customer and the customer's account. This might include, without limitation, customer name, identification, password or other security code, account numbers, and the like. Alternately, or in combination, the customer may enter some or all of this information by way of a data entry device, such as a keypad, associated with the ATM. In response to the code read by the ATM, the ATM software may execute to perform any of a number of tasks associated with assisting the customer and the bank in conducting the financial transaction. For example, the software may make a request to a host or core banking system in order to retrieve information associated with the customer's account. The software may operate to verify account and customer information, identify an account for receiving a deposit, encrypting and decrypting data, and the like.

At step 508, the electronic images created by the ATM are collected and transmitted to a manager server. At some point, either at the ATM, at the manager server, or at some other point in the system, electronic images may be associated with customer, bank, and account information so that particular images may be automatically identified as being part of a particular transaction. For example, this identifying data may be made part of the electronic file in which the image is stored.

At step 510, the manager server pulls customer, bank, and account information from the ATM. This information is associated with one or more deposited instruments and one or more particular transactions. As noted, the information may be part of the file in which the instrument image exists. Alternately, the information may be pulled by the manager server and then, at the manager server, associated with a particular instrument, image, and/or transaction.

At step 512, a virtual deposit slip is created. The virtual deposit slip includes data to reflect each of the checks associated with a particular check deposit transaction. The virtual deposit slip may comprise, for example, an electronic image of a real deposit slip of the type used by the bank for manual deposits, for example, at a teller window of a branch office. The virtual deposit slip is populated with the data associated with the checks being deposited, the customer's information, the bank and account information, and any other information desired or needed for processing the deposited items. The information may be pulled (or pushed) from the ATM, a host, a core banking system, or any other system or non-system component that has information relevant to the transaction. The manager server preferably associates the virtual deposit slip with the transaction to which it pertains.

At step 514, the manager server creates a virtual batch of transactions. The virtual batch includes multiple transactions, each of which may, for example, data and images associated with one or more checks and a virtual deposit slip. The virtual batch may include a header created as described elsewhere herein. Preferably, the virtual batch is in a format suitable to be transmitted to, and accepted by, a work station for virtual scanning and further processing.

At step 516, the manager server creates an edit priority list. An edit priority list may be associated with one or more deposit items, virtual deposit slips, batches, etc. Preferably, an edit priority list is created for, and associated with, each virtual batch. The edit priority list may be formed, and contain information, as described elsewhere herein.

At step 518, one or more virtual batches may be transmitted to a work station for verification, correction, virtual scanning, and further processing. The transmittal may occur as a result of any suitable initiation process such as a request from a work station operator, or the occurrence of an event, such as a particular time of day.

At step 520, the deposited items in a batch are virtually scanned. This may be accomplished, for example, by feeding the batch data to an emulated scanner module, which may be part or remote from the work station. A work station operator may also verify and correct data and perform other processing of deposited items. These activities may be performed prior to, during, or after the virtual scanning process.

At step 522, the virtually-scanned batch information is delivered to the bank's existing check processing system for additional processing and clearing.

It should be understood that other aspects of the invention and other embodiments will be apparent to those having ordinary skill in the art. Certain other embodiments or variations to embodiments described herein are considered to be a part of the disclosure. Modifications may be made to the systems and components described herein. For example, although various software modules are described as residing on various system components, the software modules and functionality may reside on different components than as described and in different combinations than as described. Additionally various modules may be combined and various software functionality may be provided in different combinations than as described.

What is claimed is:

1. A transaction system, comprising:
an automated teller machine operable to receive one or more items deposited by a customer;
a server connected to the automated teller machine, the server operable to collect information associated with the one or more items, batch the information, and transmit the associated information to a work station;
a work station having an emulated scanner, the work station operable to receive, and the emulated scanner operable to virtually scan, electronic versions of the one or more items.

2. The transaction system of claim 1, wherein the server is further operable to create a virtual deposit slip corresponding to the one or more items;

3. The transaction system of claim 2, wherein the server is further operable to transmit the virtual deposit slip to the work station, and wherein the emulated scanner is further operable to virtually scan the virtual deposit slip.

4. The transaction system of claim 1, wherein the server is further operable to create an edit priority list, the edit priority list comprising a listing of transactions arranged according to one or more predetermined criteria.

5. The transaction system of claim 4, wherein a portion of the associated information comprises information automatically generated by the automated teller machine in response to the deposit, and wherein the one or more predetermined criteria is a determination of whether a person depositing the items manually changed the automatically generated information.

6. The transaction system of claim 4, wherein the edit priority list is transmitted to the work station and presented to a user of the work station to enable the work station user to correct the associated information.

7. The transaction system of claim 1, wherein the server is further operable to generate a batch comprising a plurality of transactions, each of the transactions comprising a deposit of one or more items, the batch comprising a virtual batch header generated by the server.

8. A transaction system, comprising:
one or more computers, the one or more computers operable to:
receive information associated with one or more items deposited at a remote location;
create a virtual deposit slip associated with the one or more items; and
transmit the information and the virtual deposit slip to an emulated scanner for virtual scanning.

9. The transaction system of claim 8, the one or more computers being further operable to create an edit priority list, the edit priority list comprising a listing of transactions arranged according to one or more predetermined criteria.

10. The transaction system of claim 8, wherein the virtual deposit slip is populated with transaction data, at least a portion of the transaction data retrieved from the remote location.

11. The transaction system of claim 8, wherein the remote location is an ATM, and wherein the one or more items comprise one or more checks.

12. The transaction system of claim 8, the one or more computers being further operable to receive images of the one or more items from the remote location, and associate at least one of the images with at least some data corresponding to the at least one of the images.

13. The transaction system of claim 12, wherein the at least some data comprises an account number of an account held by a person depositing the items at the remote location.

14. The transaction system of claim 8, the one or more computers being further operable to create a batch of a plurality of transactions, each of the plurality of transactions comprising a deposit of one or more checks for deposit to an account, the batch comprising a virtual batch header generated by the one or more computers.

15. A method of processing one or more items deposited in at a remote location, comprising:
receiving information from the remote location, the information being associated with the one or more items;
creating a virtual deposit slip corresponding to the one or more items; and
transmitting the information and the virtual deposit slip to an emulated scanner for virtual scanning.

16. The method of claim 15, further comprising creating an edit priority list, the edit priority list comprising a listing of transactions arranged according to one or more predetermined criteria.

17. The method of claim 15, further comprising populating the virtual deposit slip with transaction data, at least a portion of the transaction data retrieved from the remote location.

18. The method of claim 15, wherein the remote location is an ATM, and wherein the one or more items comprise one or more checks.

19. The method of claim 15, further comprising receiving images of the one or more items from the remote location, and associating at least one of the images with at least some data corresponding to the at least one the images.

20. The method of claim 19, wherein the at least some data comprises an account number of an account held by a person depositing the items at the remote location.

21. The transaction system of claim 19, further comprising creating a batch of a plurality of transactions, each of the plurality of transactions comprising a deposit of one or more checks for deposit to an account, the batch comprising a virtual batch header.
